(19) United States
(12) Patent Application Publication
(10) Pub. No.: US 2016/0010540 A1
(43) Pub. Date: Jan. 14, 2016

(54) EXHAUST SYSTEM HAVING REMOTE MULTI-VALVE WASTEGATE

(71) Applicant: Electro-Motive Diesel, Inc., LaGrange, IL (US)

(72) Inventor: Nicholas Denman NORRIS, Chicago, IL (US)

(73) Assignee: Electro-Motive Diesel, Inc.

(21) Appl. No.: 14/327,083

(22) Filed: Jul. 9, 2014

(51) Int. Cl. F02B 37/18

(52) U.S. Cl. CPC F02B 37/186

(57) ABSTRACT

A wastegate is disclosed for use with a turbocharger in an exhaust system. The wastegate may have a housing at least partially defining an elongated inlet passage, and an elongated outlet passage arranged in parallel orientation relative to the elongated inlet passage. The wastegate may also have a first valve opening connecting the elongated inlet and outlet passages, and a first valve member disposed in the first valve opening and configured to move in a direction substantially orthogonal to a length direction of the elongated inlet and outlet passages. The wastegate may additionally have a second valve opening connecting the elongated inlet and outlet passages, and a second valve member disposed in the second valve opening.

### TECHNICAL FIELD

The present disclosure relates generally to an exhaust system and, more particularly, to an exhaust system having a remotely mounted multi-valve wastegate.

### BACKGROUND

Turbocharged engines often employ bypass devices, commonly known as wastegates, to regulate a turbocharger speed and a resulting boost pressure of air delivered to an intake of the engine. A typical wastegate is mounted directly to the turbocharger or associated exhaust manifold, and includes a single valve disposed within an exhaust system of the engine and a pneumatic actuator used to move the valve. The pneumatic actuator selectively moves the valve to modify a volume of exhaust gases directed into or bypassed around a turbine of the turbocharger. Boost air pressure is supplied from a compressor of the turbocharger to the pneumatic actuator to control movement of the connected valve. As boost air pressure increases, a force of the pneumatic actuator gradually urges the valve to open, thereby bypassing a greater amount of exhaust around the turbine and lowering turbocharger speed and boost air pressure. As boost air pressure decreases, the pneumatic. actuator returns the valve toward a closed position such that more exhaust passes through the turbine, thereby increasing turbocharger speed and boost air pressure.

In some applications, a greater amount of exhaust gases may need to bypass the turbine than can be provided by a single wastegate. In these situations, multiple wastegates are utilized to handle the increased volume of gases. While effective, the use of multiple wastegates can create packaging and control problems.

One attempt to improve wastegate packaging is disclosed in W.O. Patent Publication No. 2013/121111 of NYNÄS that published on Aug. 22, 2013 (“the '111 publication”), Specifically, the '111 publication describes a system having a valve arrangement for controlling gas flow in a turbocharged internal combustion piston engine. The valve arrangement includes two or more parallel valve units connected to a bypass channel of a turbocharger. Each valve unit includes a butterfly valve member, the valve members of all units being arranged in a common body. A diverging connecting member directs exhaust from the bypass channel axially through each valve unit to a converging connecting member. In this compact configuration, a large number of valves may be used to control a large flow of exhaust gas bypassing a turbine of the turbocharger.

While the system of the '111 publication may help to reduce an amount of space consumed by multiple wastegates, it may still be less than optimal. In particular, the system utilizes butterfly valve members, which may not seal completely. In addition, the design may require the valve units to be positioned axially within the bypass channel at the turbocharger, which can limit packaging options.

The present disclosure is directed at overcoming one or more of the shortcomings set forth above and/or other problems of the prior art.

### SUMMARY

In one aspect, the present disclosure is directed to a wastegate for use with a turbocharger. The wastegate may include a housing at least partially defining an elongated inlet passage and an elongated outlet passage arranged in substantially parallel orientation relative to the elongated inlet passage. The wastegate may also have a first valve opening connecting the elongated inlet and outlet passages, and a first valve member disposed in the first valve opening and configured to move in a direction substantially orthogonal to a length direction of the elongated inlet and outlet passages. The wastegate may additionally have a second valve opening connecting the elongated inlet and outlet passages, and a second valve member disposed in the second valve opening.

In another aspect, the present disclosure is directed to another wastegate. This wastegate may include a housing at least partially defining an elongated inlet passage having an open end and a closed end and an elongated outlet passage arranged in substantially parallel orientation relative to the elongated inlet passage and having an open end and a closed end. The wastegate may also include a. first valve opening connecting the elongated inlet and outlet passages, a first valve seat located at the first valve opening, and a first poppet valve disposed in the first valve opening and biased to engage the first valve seat. The wastegate may further include a second valve opening connecting the elongated inlet and outlet passages, a second valve seat located at the second valve opening, a second poppet valve biased to engage the second valve seat. The wastegate may additionally include a first pneumatic actuator configured to move the first poppet valve away from the first valve seat, and a second pneumatic actuator configured to Move the second poppet valve away from the second valve seat.

In another aspect, the present disclosure is directed to an exhaust system. The exhaust system may include an exhaust manifold configured to receive exhaust from the engine, an exhaust stack configured to direct exhaust to the atmosphere, and a turbocharger fluidly connected between the exhaust manifold and the exhaust stack. The exhaust system may also include a wastegate configured to selectively direct exhaust gases from the exhaust manifold to bypass the turbocharger and flow into the exhaust stack. The wastegate may include a housing at least partially defining an inlet passage having an open end in fluid communication with the exhaust passage and a closed end, and an outlet passage having an open end in fluid communication with the exhaust stack and a closed end. The wastegate may further include a first valve opening connecting the inlet and outlet passages, a first poppet valve disposed in the first valve opening, a second valve opening connecting the inlet and outlet passages, and a second poppet valve disposed in the second valve opening. The first and second poppet valves pass completely through the outlet passage to close off the first and second valve openings.

### BRIEF DESCRIPTION OF THE DRAWINGS

FIG. 1 is a diagrammatic illustration of an engine having an exemplary disclosed exhaust system;

FIG. 2 is an isometric illustration of an exemplary disclosed wastegate that may be used with the exhaust system of FIG. 1; and

FIG. 3 a cross-sectional illustration of the wastegate of FIG. 2.

### DETAILED DESCRIPTION

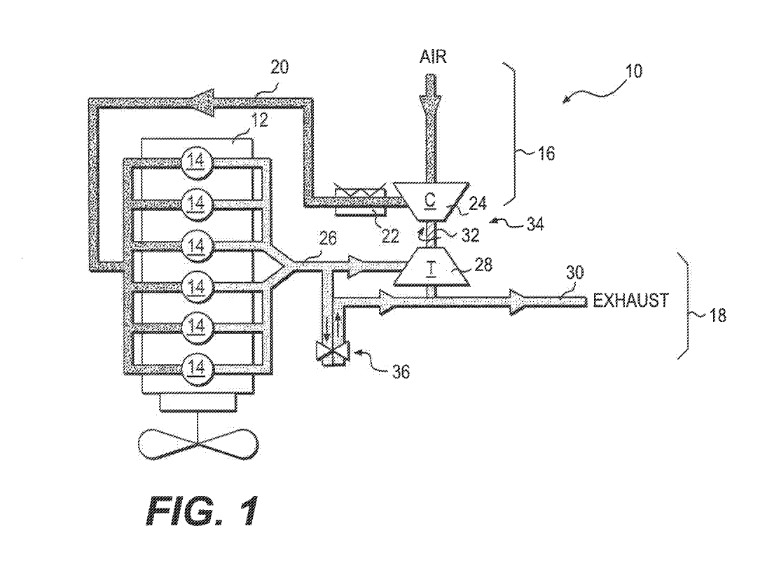

FIG. 1 illustrates an exemplary engine 10. For the purposes of this disclosure, engine 10 is depicted and described as a diesel-fueled, internal combustion engine. However, it is contemplated that engine 10 may embody any other type of combustion engine such as, for example, a gasoline-fueled engine or a gaseous fuel-powered engine burning compressed or liquefied natural gas, propane, or methane. Engine 10 may include an engine block 12 at least partially defining a plurality of cylinders 14, and a plurality of piston assemblies (not shown) disposed within cylinders 14 to form a plurality of combustion chambers (not shown). It is contemplated that engine 10 may include any number of combustion chambers and that the combustion chambers may be disposed in an in-line configuration (shown), in a “V” configuration, in an opposing-piston configuration, or in any other conventional configuration.

Multiple separate sub-systems may be associated within engine 10 and cooperate to facilitate the production of power. For example, engine 10 may include an air induction system 16 and an exhaust system 18. Air induction system 16 may be configured to direct air or an air and fuel mixture into engine 10 for subsequent combustion. Exhaust system 18 may exhaust byproducts of combustion to the atmosphere.

Air induction system 16 may include multiple components configured to condition and introduce compressed air into cylinders 14. For example, air induction system 16 may include an air cooler 22 located downstream of one or more compressors 24. Compressor(s) 24 may be connected to cooler 22 (e.g., via a passage 20), and configured to pressurize inlet air directed through cooler 22 and into cylinders 14 of engine 10. It is contemplated that air induction system 16 may include different or additional components than described above such as, for example, a throttle valve, variable valve actuators associated with each cylinder 14, filtering components, compressor bypass components, and other known components that may be selectively controlled to affect an air-to-fuel ratio of engine 10, if desired. It is further contemplated that cooler 22 may be omitted, if desired.

Exhaust system 18 may include multiple components that condition and direct exhaust from cylinders 14 to the atmosphere. For example, exhaust system 18 may include an exhaust passage 26 (e.g., an exhaust manifold), one or more turbines 28 driven by exhaust flowing through passage 26, and an exhaust stack 30 connected to an outlet of turbine(s) 28. It is contemplated that exhaust system 18 may include different or additional components than described above such as, for example, aftertreatment components, an exhaust compression or restriction brake, an attenuation device, and other known components, if desired.

Turbine(s) 28 may be located to receive exhaust leaving engine 10, and may be connected to one or more compressors 24 of air induction system 16 by way of a common shaft 32 to form a turbocharger 34. As the hot exhaust gases exiting engine 10 move through turbine(s) 28 and expand against vanes (not shown) thereof, turbine(s) 28 may rotate and drive the connected compressor(s) 24 to pressurize inlet air.

In some applications, the amount of exhaust being discharged from cylinders 14 of engine 10 may be more than a desired amount that should pass through turbine(s) 28. That is, in these situations, if all of the exhaust were to be directed through turbine(s) 28, the exhaust could cause overspeeding of turbocharger 34, excessive boost pressures, surging, and/or other related problems. For this reason, exhaust system 18 may also include a wastegate 36 fluidly connected between exhaust passage 26 and stack 30 (e.g., in parallel with turbine(s) 28). Wastegate 36 may form a portion of a bypass loop that selectively allows a controlled amount of exhaust to bypass turbine(s) 28 and flow directly from exhaust passage 26 to stack 30. The amount of exhaust that bypasses turbine(s) 28 may be controlled based on a turbocharger speed, an inlet manifold boost pressure (Le., a pressure of passage 20), a temperature (e.g., an exhaust or inlet air temperature), a fuel control value of engine 10, or based on any other parameter known in the art.

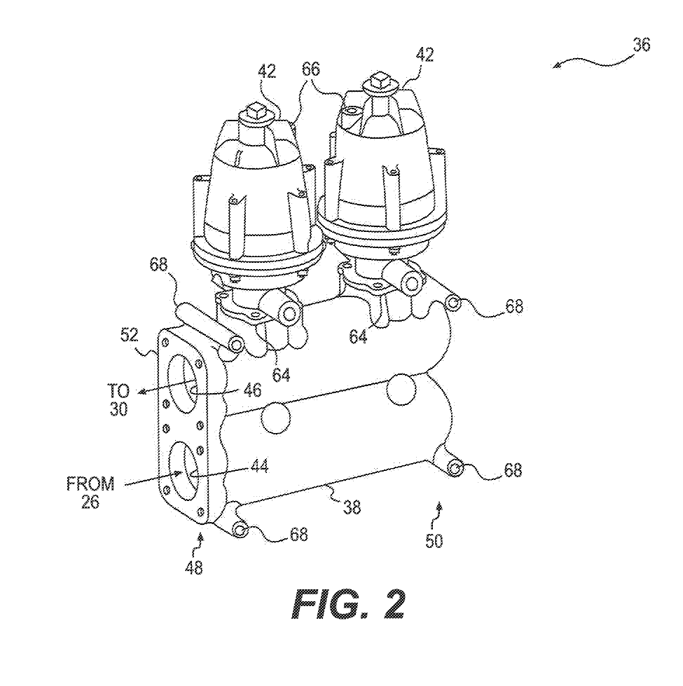

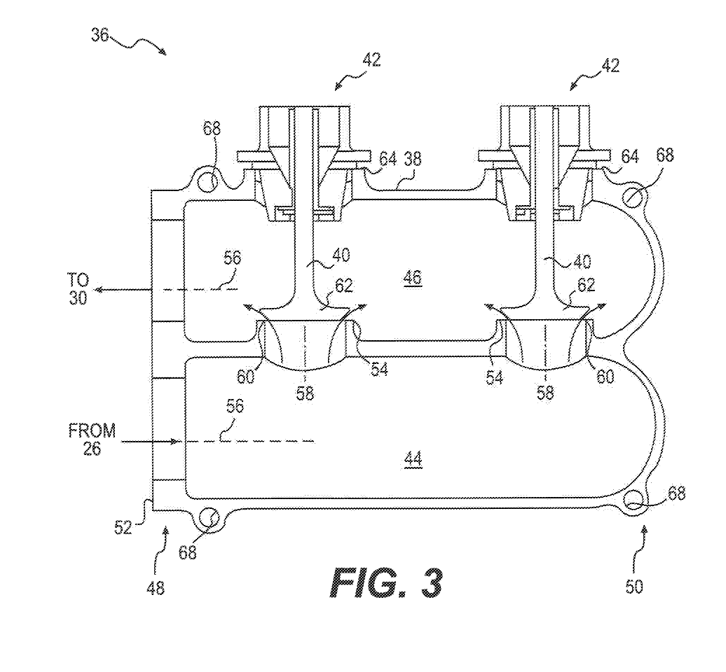

An exemplary wastegate 36 is illustrated in FIGS. 2 and 3. As can be seen in these figures, wastegate 36 may include a housing 38, a plurality of valve elements 40 (shown only in FIG. 3) movably disposed within housing 38, and an actuator 42 associated with each valve element 40. Actuators 42 may be configured to selectively move valve elements 40 between flow-blocking and flow-passing positions, to thereby fluidly communicate exhaust passage 26 with stack 30 and bypass a desired amount of exhaust around turbine(s) 28.

Housing 38 may at least partially define elongated inlet and outlet passages 44, 46, each having an open end 48 and a closed end 50. A common flange 52 may be located at open ends 48, and facilitate connection of inlet and outlet passages 44, 46 with exhaust passage 26 and exhaust stack 30, respectively. A plurality of valve openings 54 may be spaced apart in a length direction of housing 38 between open and closed ends 48, 50, and configured to fluidly connect inlet passage 44 with outlet passage 46. Although two such openings 54 are shown in FIG. 3, it is contemplated that more than two may be included, if desired. Central axes 56 of inlet and outlet passages 44, 46 may be substantially parallel (e.g., within about 0-5°) with each other, and a central axis 58 of each opening 54 may be oriented substantially (e.g., within about 0-5°) orthogonal to axes 56. In this configuration, exhaust flowing through inlet passage 44 may need to be diverted through about 180° before exiting back out of housing 38 via outlet passage 46.

Valve openings 54 may each include an annular valve seat 60 configured to be engaged by a corresponding one of valve elements 40. In particular, valve elements 40 may embody poppet type valves having a beveled annular surface 62 configured to engage seat 60 and thereby close off openings 54. As will be explained in more detail below, valve elements 40 may move between a flow-blocking position (at which elements 40 engage seats 60 blocking flow therebetween) and a flow-passing position (at which elements 40 are away from seats $0 allowing flow therebetween). Valve elements 40 may be spring biased into engagement with seats 60 and selectively moved away from seats 60 by actuators 42,

Actuators 42 may be configured to mount onto an outer wall of housing 38, for example to an outer wall of outlet passage 46. In this configuration, valve elements 40 may be generally aligned with axis 58, and pass from seats 60 completely through outlet passage 46 to actuators 42. Accordingly, the movement of valve elements 40 may be in a direction aligned with axis 58. Actuators 42 may each engage an actuator mount 64 integrally formed with (e.g., protruding from) housing 38 at the outer wall of outlet passage 46. In the disclosed embodiment, actuator mount 64 may have an engagement face that is oriented generally perpendicular to an engagement face of common flange 52.

Actuators 42 may be pneumatic type actuators, In particular, each of actuators 42 may include an inlet port 66 (shown only in FIG. 2) configured to receive a flow of compressed air (or other gas). When a pressure of the air exceeds an opening pressure of valve elements 40, valve elements 40 may be moved away from openings 60. As the pressure of the air falls below the opening pressure, valve elements 40 may be biased back into engagement with seats 60. Many conventional pneumatic actuator known in the art may be used for this purpose.

It is contemplated that actuators 42 may be operated independently and separately, or dependently and simultaneously, as desired. For example, a single manifold (not shown) could fluidly couple a high-pressure air source to both inlet ports 66 in parallel, such that both actuators 42 may be exposed to the same pressure at the same time. Assuming that both actuators 42 have the same bias acting to push valve elements 40 closed, the same control pressure should cause valve elements 40 of actuators 42 to open at the same time and by the same amount. In this same configuration, however, if a different bias is exerted on the valve elements 40 of two different actuators 42, valve elements 40 may move at different times and/or by different amounts. Alternatively, each actuator 42 may be connected to its own air source (not shown) and be controlled completely separately, as desired.

Wastegate 36 may be configured for mounting remotely from turbocharger 34. In particular, one or more mounting features 6$ may be integrally formed with housing 38, allowing wastegate 36 to be mounted in any orientation and at any location on or near engine 10. For example, the disclosed wastegate 36 is shown with four mounting bosses 68, one located at each corner of wastegate 36 (e.g., at each end of inlet and outlet passages 44, 46). This may allow for wastegate 36 to be bolted to a side of engine 10 away from turbocharger 34, and exhaust passage 26 and/or stack 30 then extended to common flange 52. It is contemplated that additional conduits, tubes, and/or hoses (not shown) may be used to connect exhaust passage 26 and/or stack 30 to wastegate 36, if desired.

### INDUSTRIAL APPLICABILITY

The disclosed exhaust system and wastegate of the present disclosure may be applicable to any engine application, where turbocharger exhaust bypass is desired in a compact space. The disclosed wastegate provides for the exhaust bypass in a compact configuration by utilizing multiple valve elements within a common housing.

Several advantages may be associated with the disclosed exhaust system and wastegate. For example, because the disclosed wastegate may utilize poppet type valves, better flow control over bypassing exhaust may be achieved. That is, poppet type valves may seal better over other types of valves commonly used in wastegate applications. In addition, because the disclosed wastegate can be mounted at any location within the exhaust system, packaging flexibility may be improved. Further, the unique configuration of inlet and outlet passages, combined with the location and operational direction of the disclosed valve elements may further improve packaging without sacrificing performance.

It will be apparent to those skilled in the art that various modifications and variations can be made to the exhaust system and wastegate of the present disclosure without departing from the scope of the disclosure. Other embodiments will be apparent to those skilled in the art from consideration of the specification and practice of the exhaust system and wastegate disclosed herein. It is intended that the specification and examples be considered as exemplary only, with a true scope of the disclosure being indicated by the following claims and their equivalents.

What is claimed is:

1. A wastegate for use with a turbocharger, comprising:
a housing at least partially defining an elongated inlet passage, and an elongated outlet passage arranged in parallel orientation relative to the elongated inlet passage;
a first valve opening connecting the elongated inlet and outlet passages;
a first valve member disposed in the first valve opening and configured to move in a direction substantially orthogonal to a length direction of the elongated inlet and outlet passages;
a second valve opening connecting the elongated inlet and outlet passages; and
a second valve member disposed in the second valve opening.

2. The wastegate of claim 1, wherein each of the first and second valve members are poppet type valves.

3. The wastegate of claim 2, further including a valve seat at each of the first and second valve openings and configured to be engaged by the first and second valve members.

4. The wastegate of claim 3, further including:
a first pneumatic actuator configured to move the first valve member; and
a second pneumatic actuator configured to move the second valve member.

5. The wastegate of claim 4, wherein:
the first and second pneumatic actuators are configured to move the first and second valve members away from the valve seats at the first and second openings; and
the first and second valve members are spring-biased toward the valve seats at the first and second openings.

6. The wastegate of claim 1, wherein each of the elongated inlet and outlet passages includes an open end and a closed end, the first and second openings being disposed between the open and closed ends.

7. The wastegate of claim 6, further including a common flange located at the open ends of the elongated inlet and outlet passages, the common flange configured to accommodate connection to exhaust passages associated with the turbocharger.

8. The wastegate of claim 7, further including mounting features located at the open and closed ends of the elongated inlet and outlet passages.

9. The wastegate of claim 8, wherein the mounting features include bosses.

10. The wastegate of claim 7, further including actuator mounts protruding from a wall of the elongated outlet passage.

11. The wastegate of claim 10, wherein the actuator mounts each include an engagement face that is oriented generally perpendicular to the common flange.

12. The wastegate of claim 10, wherein the first and second valve members pass completely through the elongated outlet passage to close off the first and second valve openings

13. A wastegate, comprising:
a housing at least partially defining an elongated inlet passage having an open end and a closed end, and an elongated outlet passage arranged in parallel orientation relative to the elongated inlet passage and having an open end and a closed end;
a first valve opening connecting the elongated inlet and outlet passages;
a first valve seat located at the first valve opening;
a first poppet valve disposed in the first valve opening and biased to engage the first valve seat;
a second valve opening connecting the elongated inlet and outlet passages;
a second valve seat located at the second valve opening;
a second poppet valve biased to engage the second valve seat;
a first pneumatic actuator configured to move the first poppet valve away from the first valve seat; and
a second pneumatic actuator configured to move the second poppet valve away from the second valve seat.

14. The wastegate of claim 13, further including actuator mounts protruding from a wall of the elongated outlet passage, wherein the first and second poppet valves pass completely through the elongated outlet passage to engage the first and second valve seats.

1. 5, An exhaust system for an engine, comprising:
an exhaust manifold configured to receive exhaust from the engine;
an exhaust stack configured to direct exhaust to the atmosphere;
a turbocharger fluidly connected between the exhaust manifold and the exhaust stack; and
a wastegate configured to selectively direct exhaust gases from the exhaust manifold to bypass the turbocharger and flow into the exhaust stack, the wastegate including:
a housing at least partially defining an inlet passage having an open end in fluid communication with the exhaust manifold and a closed end, and an outlet passage having an open end in fluid communication with the exhaust stack and a closed end;
a first valve opening connecting the inlet and outlet passages;
a first poppet valve disposed in the first valve opening;
a second valve opening connecting the inlet and outlet passages; and
a second poppet valve disposed in the second valve opening,
wherein the first and second poppet valves pass completely through the outlet passage to dose off the first and second valve openings.

16. The exhaust system of claim 15, wherein the wastegate further includes a valve seat at each of the first and second valve openings and configured to be engaged by the first and second poppet valves.

17. The exhaust system of claim 15, further including:
a first pneumatic actuator mounted to a wall of the outlet passage and configured to move the first poppet valve; and
a second pneumatic actuator mounted to the wall of the outlet passage and configured to move the second poppet valve.

18. The exhaust system of claim 17, wherein:
the first and second pneumatic actuators are configured to move the first and second poppet valves away from the valve seats at the first and second openings; and
the first and second poppet valves are spring-biased toward the valve seats at the first and second openings.

19. The exhaust system of claim 15, further including:
a common flange located at the open ends of the inlet and outlet passages, the common flange configured to accommodate connection to the exhaust manifold and the exhaust stack;
a plurality of bosses located at the open and closed ends of the inlet and outlet passages and configured to accommodate mounting of the housing remotely from the turbocharger; and
a plurality of actuator mounts protruding from a wall of the outlet passage and configured to receive the first and second pneumatic actuators.

20. The exhaust system of claim 19, wherein:
the plurality of actuator mounts each include an engagement face that is oriented generally perpendicular to the common flange; and
the plurality of bosses each include a central axis that is oriented generally perpendicular to the common flange and to the engagement faces of the plurality of actuator mounts.
